(19) United States
(12) Patent Application Publication
(10) Pub. No.: US 2018/0366110 A1
(43) Pub. Date: Dec. 20, 2018

(54) INTELLIGENT LANGUAGE SELECTION

(71) Applicant: Microsoft Technology Licensing, LLC, Redmond, WA (US)

(72) Inventors: Waseem HASHEM, Vancouver (CA); Hans Peter HESS, Vancouver (CA)

(21) Appl. No.: 15/622,556

(22) Filed: Jun. 14, 2017

(51) Int. Cl. G10L 15/183; G10L 15/00; G10L 15/06

(52) U.S. Cl. CPC G10L 15/183; G10L 2015/0635; G10L 15/063; G10L 15/005

(57) ABSTRACT

Systems and methods for generating a transcription or a translation. One system includes an electronic processor configured to detect a voice communication initiated by a sender, determine a geographic location of the sender, and access a stored mapping for the geographic location including a plurality of languages. The electronic processor is also configured to determine a plurality of candidate languages by selecting a subset of the languages included in the stored mapping, transcribe audio data received from the sender using a language model associated with each candidate language to generate a plurality of transcriptions, and determine a confidence score for each transcription. The electronic processor is further configured to select one of the transcriptions based on the confidence scores, provide the one of the plurality of transcriptions to the receiver, and update the stored mapping based on the transcription provided to the receiver.

### FIELD

Embodiments described herein relate to performing transcriptions and, in particular, using a self-learning process to select a language model for a transcription.

### SUMMARY

Transcriptions may be generated in various contexts. For example, voice mail services may generate transcriptions of voice mail messages and messaging services may similarly allow users to dictate messages. In some embodiments, these services automatically generate transcriptions using a language model, which may be set by a user. For example, when a user selects English as their default language within a voice mail service, the voice mail service transcribes voice mail messages left by or for the user using an English language model. Although this configuration may create accurate transcriptions for English voice mail messages, this configuration fails to accommodate multi-lingual users. For example, when a voice mail message is left for the user in a language other than English, the generated transcription is poor if not completely intelligible.

To improve the accuracy of transcriptions, audio data may be transcribed using a plurality of different language models and each resulting transcription may be analyzed to determine the most accurate transcription. Generating a transcription for each of a large quantity of possible languages, however, takes considerable processing resources and time. Accordingly, generating such a large number of transcriptions may be difficult or impossible in some situations or may introduce unwanted delays.

Thus, embodiments described herein provide methods and systems for building artificial intelligence that uses information, like the geographic location of a user, to narrow down the potential languages for a transcription. A feedback mechanism uses the accuracy of generated transcriptions to improve this artificial intelligence over time.

For example, one embodiment provides a system for generating a transcription. The system includes a server including an electronic processor. The electronic processor is configured to detect a voice communication to a receiver initiated by a sender, determine a geographic location of the sender, access a stored mapping for the geographic location, the stored mapping including a plurality of languages associated with the geographic location, and determine a plurality of candidate languages for the sender by selecting a subset of the plurality of languages included in the stored mapping. The electronic processor is also configured to transcribe audio data received from the sender using a language model associated with each of the plurality of candidate languages to generate a plurality of transcriptions, determine a confidence score for each of the plurality of transcriptions, and select one of the plurality of transcriptions based on the confidence score for each of the plurality of transcriptions. The electronic processor is further configured to provide the one of the plurality of transcriptions to the receiver, and update the stored mapping based on the one of the plurality of transcriptions provided to the receiver.

Another embodiment provides a method for converting data using a language model. The method includes determining, with an electronic processor, a first property of a first user, and accessing, with the electronic processor, a stored mapping for the first property. The stored mapping includes a plurality of languages associated with the first property, wherein each of the plurality of languages has an assigned score. The method also includes determining, with the electronic processor, a first plurality of candidate languages for the first user by selecting a first subset of the plurality of languages included in the stored mapping based on the assigned score of each of the plurality of languages, receiving, with the electronic processor, first data from the first user, and converting, with the electronic processor, the first data into second data using a language model associated with each of the first plurality of candidate languages to generate a first plurality of data conversions. The method further includes determining, with the electronic processor, a confidence score for each of the first plurality of data conversions, and selecting, with the electronic processor, one of the first plurality of data conversions based on the confidence score for each of the first plurality of data conversions. In addition, the method includes updating, with the electronic processor, the stored mapping based on the one of the first plurality of data conversions. The method further includes determining, with the electronic processor, a second property of a second user. In response to the second property matching the first property, the method also includes accessing, with the electronic processor, the stored mapping as updated, determining, with the electronic processor, a second plurality of candidate languages for the second user by selecting a second subset of the plurality of languages included in the stored mapping based on the assigned score of each of the plurality of languages, and converting, with the electronic processor, third data into fourth data using a language model associated with each of the second plurality of candidate languages.

A further embodiment provides a non-transitory, computer-readable medium storing instructions that, when executed by an electronic processor, perform a set of functions. The set of functions includes determining a property of at least one selected from a group consisting of a user and data and accessing a stored mapping for the property. The stored mapping includes a plurality of languages associated with the property, wherein each of the plurality of languages has an assigned score. The set of functions also includes determining a plurality of candidate languages by selecting a subset of the plurality of languages included in the stored mapping based on the assigned score of each of the plurality of languages and converting the data using a language model associated with each of the plurality of candidate languages to generate a plurality of data conversions. The set of functions further includes determining a confidence score for each of the plurality of data conversions, selecting one of the plurality of data conversions based on the confidence score for each of the plurality of data conversions, and updating the stored mapping based on the one of the plurality of data conversions.

### BRIEF DESCRIPTION OF THE DRAWINGS

FIG. 1 schematically illustrates a system for transcribing audio data.

FIG. 2 schematically illustrates a transcription server included in the system of FIG. 1.

FIG. 3 schematically illustrates an example mapping for a geographic location.

FIG. 4 schematically illustrates an example mapping for an enterprise.

FIG. 5 schematically illustrates an example mapping for voice mail transcriptions.

FIG. 6 is a flow chart illustrating a method for transcribing audio data performed by the system of FIG. 1.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As noted above, transcription accuracy is largely impacted by whether the appropriate language is used. One way to select an appropriate language is to use a language set by a user, such as a language included in a user profile. This process, however, requires a profile for every user, which may be difficult to create and maintain. For example, a voice mail service may be used by thousands or millions of users, some of whom may be using the service for the first time or may not have an existing profile. Furthermore, even if a profile could be established for each potential user, the profiles still fail to account for multi-lingual users.

Another way to select an appropriate language is to transcribe audio data for each of a plurality of languages and then select the most accurate transcription. This process, however, requires processing resources and time. For example, transcribing a voice mail message or other streaming audio data in each of a large number of languages requires extensive processing resources and could introduce unwanted delay.

Accordingly, embodiments described herein improve transcription quality by selecting a plurality of candidate languages (for example, two to four languages) for audio data, generating a transcription of the audio data based on each of the plurality of candidate language, determining a confidence score for each transcription, and selecting the transcription with the highest confidence score. The candidate languages are selected based on a property of a source of the audio data, a receiver of the audio data, the audio data itself, or a combination thereof. For example, as described in more detail below, the candidate languages may be selected based on the geographical location of the source of the audio data. In particular, within a voice mail service, the systems and methods described herein may determine a geographical location of a sender of a voice mail message and select the most likely languages for that geographical location as the candidate languages. Similarly, the systems and methods described herein may determine an enterprise, such as a company, a school, or an organization, that a sender of a voice mail message is associated with (involved in or employed by) and select the most likely languages for that organization. Thus, rather than generating a transcription for every possible language, the systems and methods generate a transcription for each of a more limited set of candidate languages, which allows transcriptions to be generated in parallel without wasting processing resources or time. Furthermore, this process does not rely on profiles or other stored data for individual users that set default languages. Rather, by identifying a property of a user or audio data, the property can be used to determine likely languages for users or data with the identified property.

In addition, a feedback mechanism allows the systems and methods to automatically learn and improve over time. For example, a geographic location may be associated with a plurality of languages and each of the plurality of languages may be associated with a score. These scores may be used to select a set of candidate languages as described above for transcribing audio data. For example, the languages with the three highest scores may be selected and used to transcribe the audio data and a confidence score is determined for each transcription representing the accuracy of the transcription. These confidence scores are then used to update a mapping. As one example, assume a geographic location is historically associated with English, Spanish, and French speakers and these three languages may be included in the set of candidate languages for audio data, such as voice mail messages, originating from the geographic location. When, over time, transcriptions for voice mail messages originating from this geographic location experience a low confidence score when using a French language model, the score for the French language associated with the geographic location may be updated (decreased). Based on this update, French may eventually no longer have a top score and may be replaced by a different candidate language for the geographic location. Thus, the systems and methods described herein self-learn to associate particular candidate languages with particular properties.

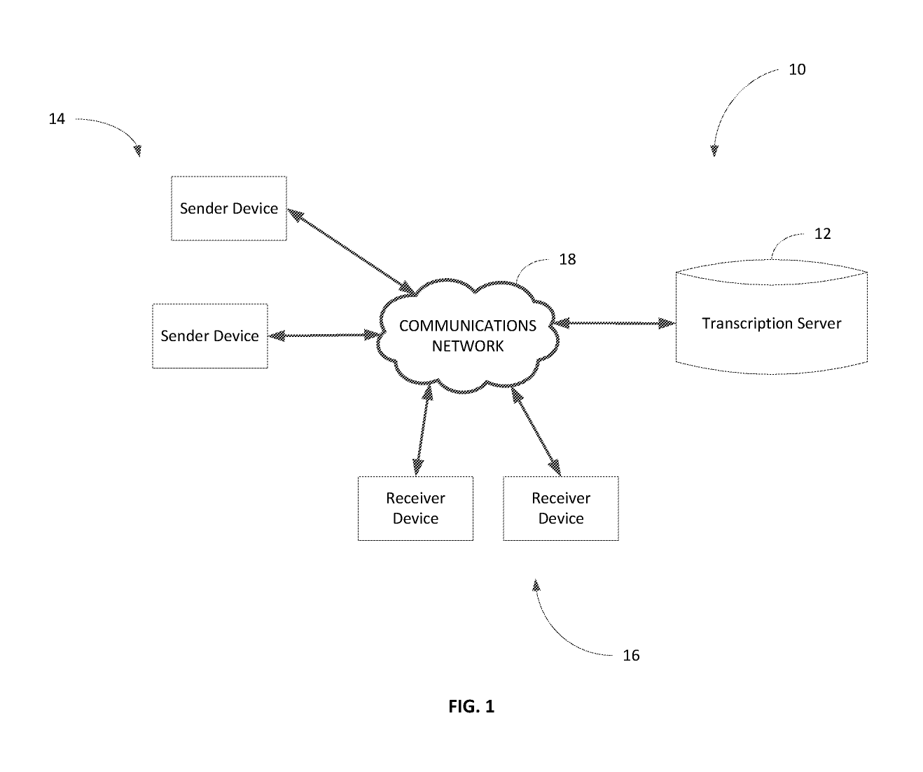

FIG. 1 illustrates a system 10 for transcribing audio data. The system 10 includes a transcription server 12, a plurality of sender devices 14 (referred to individually as a “sender device 14” and collectively as “sender devices 14), and a plurality of receiver devices 16 (referred to individually as a “receiver device 16” and collectively as “receiver devices 16”). The system 10 is provided as one example and, in some embodiments, the system 10 includes fewer or additional components. For example, although two sender devices 14 and two receiver devices 16 are illustrated in FIG. 1, the system 10 may include many more sender devices, receiver devices, or both. Also, the functionality described herein as being performed by the transcription server 12 may be distributed among multiple servers. For example, in some embodiments, the functionality of the transcription server 12 is provided through a cloud service that uses a plurality of servers.

The transcription server 12, the sender devices 14, and the receiver devices 16 are communicatively coupled by at least one communications network 18. The communications network 18 may be implemented using a wide area network, such as the Internet, a local area network, such as a Bluetooth™ network or Wi-Fi, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a voice-over-IP (Internet Protocol) (VoIP) network, a public switched telephone network, and combinations or derivatives thereof. In some embodiments, rather than or in addition to communicating over the communications network 18, the transcription server 12, the sender devices 14, and the receiver devices 16, or a combination thereof, communicate over one or more dedicated (wired or wireless) connections. In addition, in some embodiments, the transcription server 12, the sender devices 14, the receiver devices 16, or a combination thereof may communicate over one or more intermediary devices, such as routers, servers, gateways, relays, and the like. In some embodiments, a sender device 14 and a receiver device 16 may use different communication networks to communicate with the transcription server 12. As one example, a sender device 14 may use a public switched telephone network to initiate a call and leave a voice mail message, and the transcription server 12 may transcribe the voice mail message and make the transcription accessible via a receiver device 16 over the Internet.

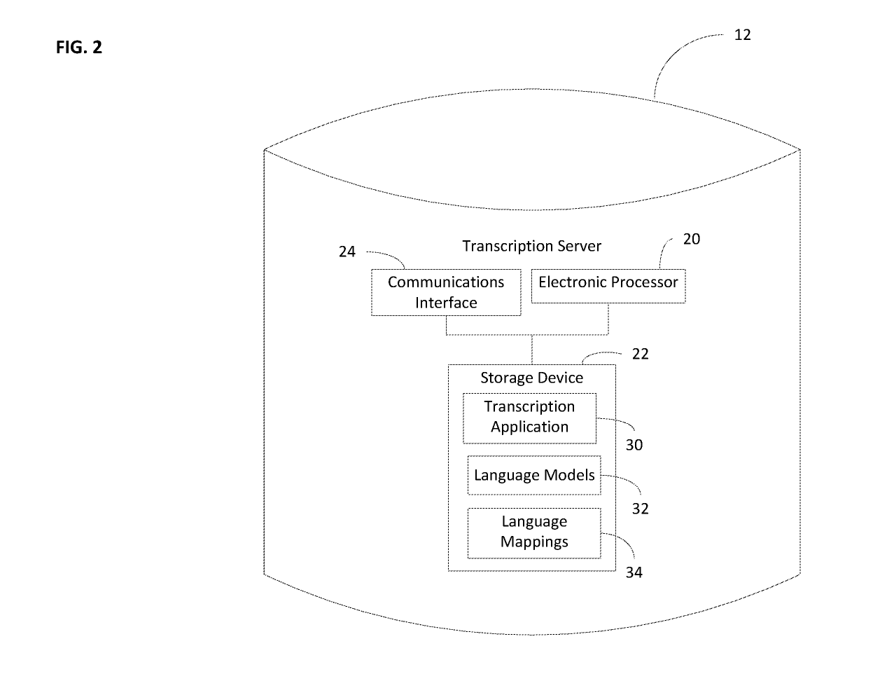

As illustrated in FIG. 2, the transcription server 12 is a computing device that includes an electronic processor 20, a memory 22, and a communications interface 24. The components of the transcription server 12 communicate wirelessly, over one or more communication lines or buses, or a combination thereof. As described in more detail below, the transcription server 12 is configured to receive audio data and generate a transcription of the received audio data. In some embodiments, the transcription server 12 includes additional, fewer, or different components than those illustrated in FIG. 1. For example, in some embodiments, the transcription server 12 also includes one or more human machine interfaces (HMI), such as one or more buttons, a keypad, a keyboard, a display, a touchscreen, a speaker, a microphone, and the like. The HMIs allow a user to interface with the transcription server 12. In addition, in some embodiments, the transcription server 12 is configured to perform additional functionality not described herein. For example, the transcription server 12 may be configured to manage communications between users, such as voice communications, in addition to generating transcriptions for voice mail messages.

The communications interface 24 included in the transcription server 12 may include a wireless transmitter or transceiver for wirelessly communicating over the communications network 18. Alternatively or in addition to a wireless transmitter or transceiver, the communications interface 24 may include a port for receiving a cable, such as an Ethernet cable, for communicating over the communications network 18 or a dedicated wired connection.

The electronic processor 20 may include a microprocessor, an application-specific integrated circuit (ASIC), or another suitable electronic device configured to receive and process data. The memory 22 includes a non-transitory, computer-readable storage medium that stores program instructions and data. The electronic processor 20 is configured to retrieve from the memory 22 and execute, among other things, software (executable instructions) to perform a set of functions, including the methods described herein. For example, as illustrated in FIG. 2, the memory 22 stores a transcription application 30. As described in more detail below, the transcription application 30, when executed by the electronic processor 20, transcribes audio data. In some embodiments, the functionality described herein as being performed by the transcription application 30 may be distributed among multiple applications.

As illustrated in FIG. 2, the memory 22 also stores a plurality of language models 32 and a plurality of language mappings 34. In some embodiments, the language models 32, the language mappings 34, or both are included in the transcription application 30. Also, in some embodiments, the language models 32, the language mappings 34, or both are stored in a separate memory of the transcription server 12 or a separate device that communicates with the transcription server 12.

The transcription application 30 uses the language models 32 to generate transcriptions, and, as described in further detail below, the transcription application 30 uses the language mappings 34 to select candidate languages for a transcription. Each language mapping 34 associates a property with a plurality of languages wherein each of the plurality of languages has an assigned score. An assigned score may indicate an accuracy of the language when generating transcriptions, a rank of the language in generating accurate transcriptions, or the like. The property of each mapping may include a property of a data source, such as a sender of a voice mail message, a property of a data recipient, such as a receiver of a voice mail message, a property of audio data being transcribed, or a combination thereof. In general, a property may be any feature or characteristic of a user or data that, although may not uniquely identify the user or the data, categorizes the user or data such that likely languages can be selected more intelligently than a random or default selection. For example, a property may be a geographic location, such as Vancouver, Clarke County, Del., area code 414, or the like. Similarly, a property may be an enterprise (such as a company, a school, an organization, or the like), an age, a profession, a gender, a date or time of day, an Internet service provider (ISP), a type of communication channel or network, or the like.

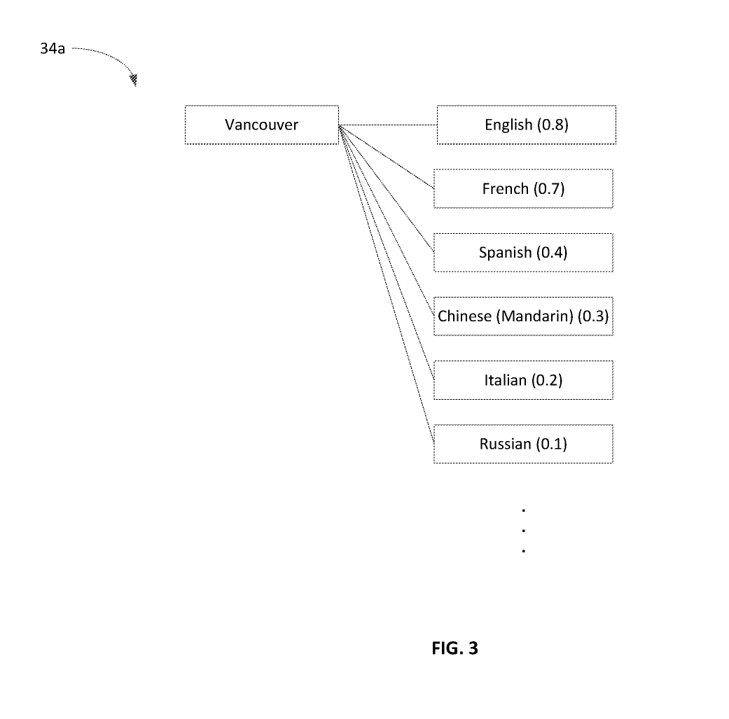

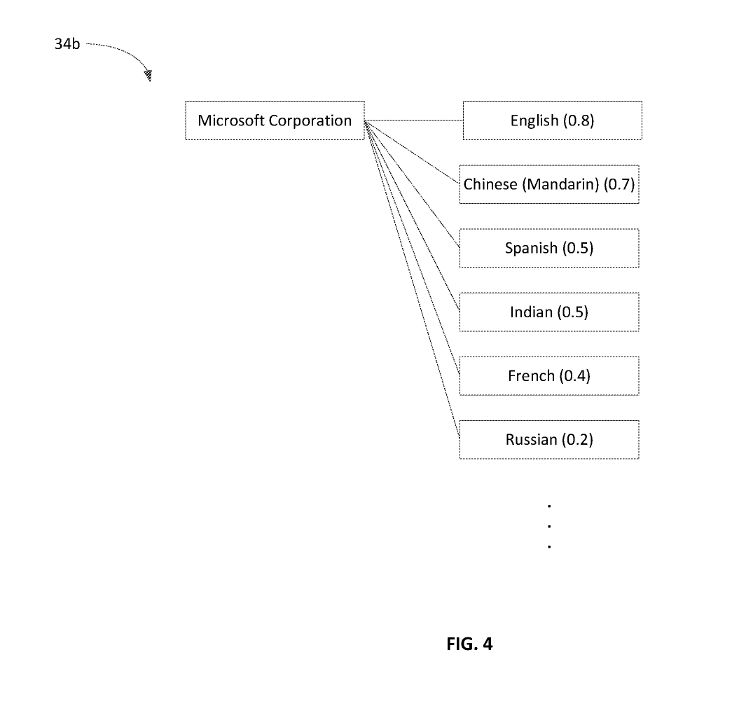

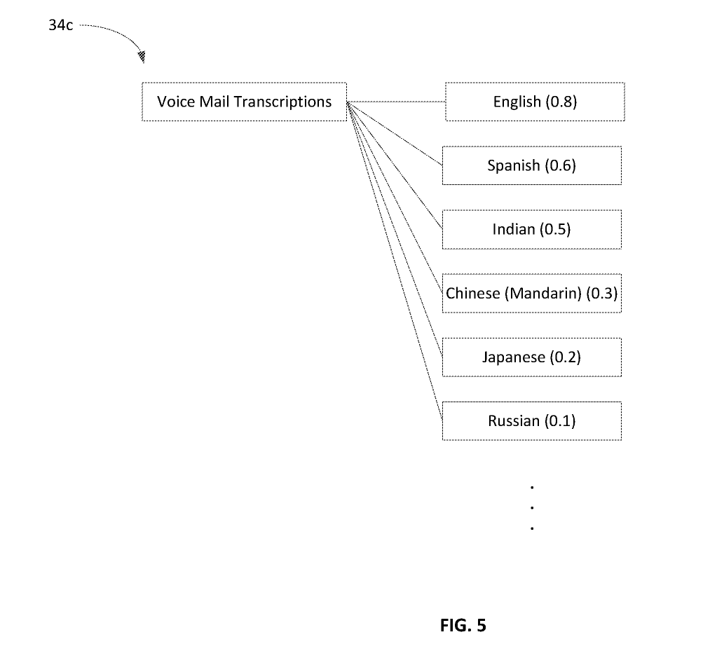

For example, FIG. 3 schematically illustrates an example language mapping 34a for a geographic location. As illustrated in FIG. 3, the language mapping 34a associates Vancouver with a plurality of languages wherein each language has an assigned score. FIG. 4 schematically illustrates another example language mapping 34b for an enterprise. As illustrated in FIG. 4, the language mapping 34b associates Microsoft Corporation with a plurality of languages wherein each language has an assigned score. FIG. 5 schematically illustrates yet another example language mapping 34c for a type of transcription. For example, the transcription server 12 may be configured to perform transcriptions in various contexts, such as transcribing streaming voice mail messages, transcribing streaming voice communications, generating transcriptions from stored audio files, transcribing voice commands, and the like. Accordingly, a mapping may establish, through scores, the likely languages for each type of transcription. For example, as illustrated in FIG. 5, the language mapping 34c associates voice mail transcriptions with a plurality of languages wherein each language has an assigned score and similar separate language mappings 34 may be established for other types of transcriptions.

In general, each language mapping 34 establishes a list of languages for a property, wherein each language has an assigned score. Accordingly, rather than setting languages for individual users, the mappings are used, as described in more detail below, to define likely languages for particular types or groups of users or particular types of groups of data. In some embodiments, each language mapping 34 includes the same set of languages, but the languages in each language mapping 34 may have different assigned scores. In other embodiments, a language mapping 34 may be associated with different languages than another language mapping 34. Also, the languages included in a language mapping 34 may include distinct languages as well as different dialects or versions of languages, such as British English and American English.

The format and type scores included in a language mapping 34 may vary. For example, the example scores illustrated in FIGS. 3, 4, and 5 are values between 0 and 1, where the closer the score is to 1 the higher the likelihood that the language generates an accurate transcription. In other embodiments, the scores may be provided in other formats, such as percentages between 0 and 100% representing a likelihood of generating an accurate transcription, a rank among all of the plurality of languages representing a likelihood or frequency of generating an accurate transcription, or the like. Furthermore, in some embodiments, an opposite scale may be used where the higher the score, the lower the likelihood that the language will generate an accurate transcription. Furthermore, in some embodiments, the score represents a number or percentage of transcriptions where the associated language provided the most accurate transcription. For example, a score of 0.7 or 70% may indicate that 70% of generated transcriptions were accurately generated using the language. In some embodiments, a language may also be assigned multiple different scores, such as an average, minimum, or maximum confidence score when a language is used to generate a transcription, a percentage of times the language provides the most accurate transcription, or a combination thereof.

Returning to FIG. 1, the sender devices 14 are user devices configured to transmit audio data to the transcription server 12. For example, a sender device 14 may include a telephone, a laptop computer, a desktop computer, a tablet computer, a computer terminal, a smart telephone, a smart watch or other wearable, a smart television, a server, a database, and the like. Similarly, the receiver devices 16 are user devices configured to receive a transcription of audio data from the transcription server 12. Thus, a receiver device 16 may include a telephone, a laptop computer, a desktop computer, a tablet computer, a computer terminal, a smart telephone, a smart watch or other wearable, a smart television, a server, a database, and the like. In some embodiments, the sender devices 14, the receiver devices 16, or both include similar components as the transcription server 12. For example, the sender devices 14, the receiver devices 16, or both may include an electronic processor, a memory, a communication interface, an HMI, or a combination thereof.

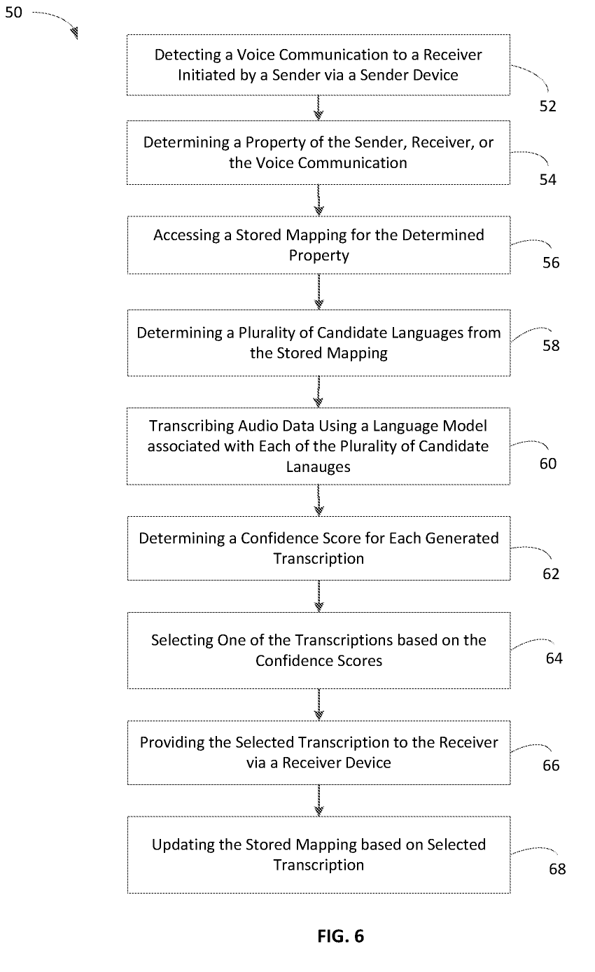

FIG. 6 illustrates a method 50 for generating a transcription using the system 10. The method 50 is described herein as being performed by the transcription server 12 (the transcription application 30 as executed by the electronic processor 20) and, in particular, is described as being performed within the context of transcribing voice mail messages. However, as noted below, the method 50 may be applied in other configurations and contexts, including transcriptions unrelated to voice communications or voice mail messages.

As illustrated in FIG. 6, the method 50 includes detecting, with the transcription server 12, a voice communication to a receiver initiated by a sender via a sender device 14 (at block 52). For example, when a sender uses the sender device 14 to initiate a voice communication to the receiver, such as by dialing a phone number of the receiver, and the receiver is not available (does not answer the call), the transcription server 12 may detect this situation and start a transcription service for a voice mail message left by the sender. In other embodiments, the transcription server 12 may be configured to start a transcription service for voice mail messages while the sender waits for the receiver to answer the voice communication. Also, in some embodiments, other systems or devices may signal the transcription server 12 to initiate transcription services.

To provide transcription services, the transcription server 12 also determines a property of the sender, the receiver, or the voice communication (at block 54). For example, the transcription server 12 may be configured to determine a geographic location of the sender. The transcription server 12 may determine the geographic location of the sender based on a phone number (area code) of the sender, an IP address of the sender device 14, metadata included in the voice communication (such as in a VoIP communication), or the like. Similarly, in some embodiments, when the transcription server 12 has access to a user profile of the sender (such as within an active directory of users), the transcription server 12 may access the profile to determine a geographic location of the sender.

As illustrated in FIG. 6, the transcription server 12 accesses a stored language mapping 34 for the determined property (at block 56). For example, when the property includes the geographic location of the sender, the transcription server 12 accesses a stored language mapping 34 for the geographic location, such as the example language mapping 34a illustrated in FIG. 3. As illustrated in FIG. 3, a mapping may associate a geographic location, such as Vancouver, with a plurality of languages, wherein each language has an assigned score for the geographic location. As noted above, the score of each language may specify how accurate transcriptions are based on the language when the language is used to transcribe audio data originating from the geographic location. Alternatively or in addition, the score of each language may specify how frequently (such as a count or a percentage of transcriptions) the language provides the most accurate transcription for audio data originating from the geographic location. For example, using the example language mapping 34a illustrated in FIG. 3, the English language may (on average) generate transcriptions of audio data originating from Vancouver with a score of 0.7. Alternatively or in addition, the English language may generate the most accurate transcription for 70% of transcriptions generated for audio data originating from Vancouver.

As illustrated in FIG. 6, based on the mapping, the transcription server 12 determines a plurality of candidate languages for the sender by selecting a subset of the plurality of language included in the stored language mapping 34 based on the assigned score of each of the plurality of languages (at block 58). For example, the transcription server 12 may be configured to select two to four languages from the language mapping 34 that have the highest assigned scores, select all languages with an assigned score greater than a threshold, or a combination thereof. The number of candidate languages, the threshold, or both may be configurable and may be based on the scores assigned to the languages. For example, when no or only a few (less than two or another predetermined number) languages have scores exceeding a predetermined minimum score, the transcription server 12 may select more languages as candidate languages than when a plurality of the languages have scores exceeding the predetermined minimum score.

In some embodiments, the transcription server 12 selects candidate languages from multiple language mappings 34. For example, when the sender is associated with Vancouver and works for a particular company, the transcription server 12 may access a stored language mapping 34 for each of these properties to build the plurality of candidate languages. Similarly, the transcription server 12 may be configured to determine one or more properties of both the sender and the receiver and may access multiple language mappings 34. For example, the transcription server 12 may access a first language mapping 34 for the geographic location of the sender and a second language mapping 34 for the geographic location of the receiver and may define the candidate languages as the two languages from each language mapping 34 having the highest scores. Similarly, in some embodiments, when user profiles are available that specify a preferred or default language of the sender, the receiver, or both, the transcription server 12 may add these languages to the candidate languages.

With candidate languages selected, the transcription server 12 transcribes audio data received from the sender (the voice mail message) via the sender device 14 using a language model 32 associated with each of the plurality of candidate languages to generate a plurality of transcriptions (at block 60). The transcription server 12 may cache the generated transcriptions, such as within a cloud service. In some embodiments, the transcription server 12 transcribes audio data in a streaming or real-time fashion as a voice mail message is recorded. In other embodiments, the transcription server 12 transcribes audio data after the voice mail message is recorded. In either situation, the transcription server 12 may be configured to generate the transcriptions in parallel, serially, or in a combination thereof.

The transcription server 12 also determines a confidence score for each of the plurality of transcriptions (at block 62) and selects one of the plurality of transcriptions based on the confidence score for each of the plurality of transcriptions (at block 64). The transcription server 12 may determine the confidence scores by determining how well a generated transcription satisfies various grammar rules of a language or how many words or phrases could or could not be transcribed. Other techniques for determining the accuracy of a transcription are known and, thus, are not described herein in detail. In some embodiments, the transcription server 12 selects, from the plurality of transcriptions, the transcription having the highest confidence score. However, depending on the type and format of the confidence scores, the transcription server 12 may select the transcription with the lowest confidence score. In some embodiments, the transcription server 12 also generates multiple confidence scores for a single transcription, and the transcription server 12 may consider all of the confidence scores (such as through an average score) when selecting the most accurate transcription. In some embodiments, the transcription server 12 may be configured to only select a transcription when the confidence score of the transcription exceeds a minimum score. For example, when each of the candidate languages results in a transcription with a low confidence score (below a predetermined minimum confidence score), the transcription server 12 may be configured to generate an error or select a new set of candidate languages as described above and generate new transcriptions (using the recorded voice mail message).

The transcription server 12 provides the selected transcription to the receiver via a receiver device 16 (at block 66). The transcription server 12 may provide the selected transcription to the receiver by sending a communication to the receiver device 16, such as an email message that includes the selected transcription as an attachment. Alternatively or in addition, the transcription server 12 may send a communication to the receiver device 16 (such as an email message) alerting the receiver that a transcription is stored (cached in cloud service) and is available for access. For example, as noted above, the receiver device 16 may include a computing device that may execute (using an electronic processor) a browser application to access a web page or portal where the receiver can access and download the transcription.

As illustrated in FIG. 6, the transcription server 12 also updates the stored language mapping 34 based on the confidence score of the selected transcription provided to the receiver (at block 68). In some embodiments, the transcription server 12 updates the score assigned to the language associated with the selected transcription within the mapping based on the confidence score of the selected transcription. For example, when the mapping includes the English language with a score of 0.6 and the selected transcription had a confidence score of 0.7, the transcription server 12 may update the mapping such that the English language has a matching score of 0.7. Alternatively or in addition, the transcription server 12 may increase the score of the language in the mapping by a predetermined amount, may average the two scores, or the like. For example, as noted above, the score assigned to a language within a mapping may specify how many times the language was associated with a selected transcription (the most accurate transcription). Thus, in these configurations, the transcription server 12 may increment the score to track another accurate transcription generated using the language.

As another example, the transcription server 12 may update a language mapping 34 by adding another language-score record to the language mapping 34. The new record may include the language used to generate the selected transcription and the confidence score of the transcription (or a score set based on this confidence score). In this configuration, the updated language mapping 34 may include a number of records for the same language, each with an associated score. Updating a language mapping 34 by adding new records allows the language mapping 34 to track both what languages are associated with accurate transcriptions as well as variances of confidences scores for this language. In particular, using these multiple records for languages, the transcription server 12 may determine what languages are most often associated with selected transcriptions (by counting entries for unique languages), what the average confidence score is for a particular language (by averaging confidence scores for the language), and the like.

In some embodiments, in addition to or as an alternative to updating a score or other data associated with the language that was used to generate the selected transcription, the transcription server 12 may be configured to update the score or other data associated with other languages. For example, when candidate languages were used to generate transcriptions and these transcriptions were not selected (did not have the highest confidence score or had low confidence scores), the transcription server 12 may decrease the score of these languages within the mappings or make other updates to decrease the likelihood that these languages are selected as candidate languages in subsequent transcriptions.

In some embodiments, the transcription server 12 also updates a language mapping 34 based on feedback from the sender, the receiver, or a third-party. For example, the sender, the receiver, or a third-party (a transcription reviewer or quality control personnel) may access the selected transcription and may provide feedback regarding the accuracy of the transcription. The feedback may include an indication of whether the transcription was generated in the correct language (and, optionally, what the correct language is). When the transcription server 12 receives such feedback regarding an incorrect language selection, the transcription server 12 may update a language mapping 34 by deleting entries previously added to the language mapping 34 for the transcription or updating one or more scores in the language mappings 34. For example, the transcription server 12 may decrease the score for the erroneously-selected language (by a predetermined amount) and, optionally, may increase the score for the correct language that should have been selected (by a predetermined amount).

These updates to a language mapping 34 allow the language mappings 34 to build intelligence over time. For example, when a geographic location experiences a change in population and an associated change in common languages, the language mapping 34 associated with the geographic language automatically adjust to these changes. In particular, as a language repeatedly provides inaccurate transcriptions, the score of the language within a language mapping 34 may decrease, which may cause the language to no longer be selected as a candidate language and may allow other languages to be selected as a candidate language. For example, when a first sender of a voice mail message is located in Vancouver, the stored language mapping 34 for Vancouver may include, among other languages, English, French, and Spanish and these languages may represent the languages with the top three assigned scores. If, however, the transcription of the voice mail message using Chinese has the greatest accuracy, the stored language mapping 34 for Vancouver may be updated such that Chinese now has a score within the three highest scores. Accordingly, when a second sender leaves a voice mail message and the second sender has a property that matches the property of the first sender (the second sender is also located in Vancouver), the transcription server 12 uses the updated language mapping 34 to make an updated “guess” at the possible languages for the voice mail message from the second sender.

As noted above, although embodiments are described above with reference to transcribing a voice mail message, the systems and methods described herein may be used to generate transcriptions in other contexts. For example, the systems and methods may be used to transcribe voice commands, transcribe stored audio data files, and the like. In particular, a user may be able to upload (via a sender device 14) an audio data file to the transcription server 12, and the transcription server 12 may transcribe the audio data file as described above (but not in a streaming environment). In these configurations, the transcription server 12 may be configured to select the candidate languages based on the geographic location of the user requesting the transcription, such as via an IP address, an email address, metadata of the audio data file, or the like. For example, when a user submits a request for a transcription to the transcription server 12 via an email message that includes the audio data file as an attachment (optionally along with the audio data of voice mail message), the transcription server 12 may determine a geographical location of the user based on the user's IP address, email address, or other identifying information. Similarly, when a user submits a request for a transcription via a web page accessed by a sender device 14 using a browser application, the transcription server 12 may determine a geographical location of the user based on the user's IP address. In other embodiments, the transcription server 12 may be configured to select the candidate languages based on metadata of the audio data file, such as an IP address of a device where the audio data file was created, a type of the audio file (a file extension), and the like. In this situation, rather than providing a generated transcription to a receiver different from the sender providing the audio data, the transcription server 12 may provide a generated transcription to the same user who provided the audio data file. Accordingly, in these situations, a sender device 14 as described above may also function as a receiver device 16.

Furthermore, in some embodiments, the systems and methods described above may be used to generate translations. For example, rather than converting audio data to text data, the transcription server 12 may be configured to convert audio data in one language to audio data in another language or convert text data in one language to text data in another language, including a streaming environment where real-time translations are provided. Again, in these situations, the transcription server 12 may be configured to determine a property of a translation, such as geographical location of a user, a data type, an enterprise associated with a user, and the like, and use the property to determine a plurality of candidate languages as described above. Accordingly, the systems and methods described herein may be used to generate data conversions in general and are not limited to converting audio data to text data as part of generating a transcription.

As another example, the transcription server 12 may be configured to generate a transcription as described above with respect to FIG. 6 and then translate the transcription into a plurality of languages. For example, in some embodiments, the transcription server 12 may be configured to allow voice mail messages for a group of users. In this configuration, the transcription server 12 may be configured to transcribe the voice mail message as described above and then translate the transcription for each user in the group (who may speak one or more different languages) using candidate languages for each user in the group as described above.

Furthermore, in some embodiments, the functionality described above as being performed by the transcription server 12 (or a portion thereof) may be performed by a sender device 14, a receiver device 16, or a combination thereof. For example, when a receiver device 16 receives a voice mail message, the receiver device 16 may be configured to execute the transcription application 30 as described above to locally generate a transcription for the voice mail. In this configuration, the receiver device 16 may access locally-stored language models 32, language mappings 34, or both. Alternatively or in addition, the receiver device 16 may access one or more language models 32, language mappings 34, or both accessible through the transcription server 12. Similarly, in some embodiments, the sender device 14 may generate a transcription of audio data received via the sender device 14 and provide the transcription to the receiver device 16 (directly or through the transcription server 12).

Thus, embodiments described herein provide systems and methods for selecting candidate languages for transcriptions or translations, wherein the candidate languages are based on one or more properties, such as properties of users, data, or the like. Accordingly, individual user profiles specifying languages are not required and the systems and methods can address multi-lingual users. The mappings used to select the candidate languages are also updated to track the accuracy of candidate languages, which allows candidate languages to automatically adjust to changes in user demographics. Accordingly, the mappings and the feedback mechanism associated with such mappings efficiently build intelligence for selecting candidate languages for transcriptions and translations.

Various features and advantages of some embodiments are set forth in the following claims.

What is claimed is:

1. A system for generating a transcription, the system comprising:
a server including an electronic processor configured to detect a voice communication to a receiver initiated by a sender,
determine a geographic location of the sender,
access a stored mapping for the geographic location, the stored mapping including a plurality of languages associated with the geographic location,
determine a plurality of candidate languages for the sender by selecting a subset of the plurality of languages included in the stored mapping,
transcribe audio data received from the sender using a language model associated with each of the plurality of candidate languages to generate a plurality of transcriptions,
determine a confidence score for each of the plurality of transcriptions,
select one of the plurality of transcriptions based on the confidence score for each of the plurality of transcriptions,
provide the one of the plurality of transcriptions to the receiver, and
update the stored mapping based on the one of the plurality of transcriptions provided to the receiver.

2. The system of claim 1, wherein the electronic processor is further configured to
detect a second voice communication to a second receiver initiated by a second sender,
determine a second geographic location of the second sender, and
in response to the second geographic location of the second sender matching the first geographic location of the first sender,
access the stored mapping for the geographic location as updated, and
determine a second plurality of candidate languages for the second sender by selecting a second subset of the plurality of languages included in the stored mapping.

3. The system of claim 1, wherein the electronic processor is configured to determine the geographic location of the sender based on at least one selected from a group consisting of a phone number of the sender, an Internet Protocol (IP) address of a sender device used by the sender, metadata included in the voice communication, and a profile of the sender.

4. The system of claim 1, wherein the subset of the plurality of languages includes each of the plurality of languages included in the stored mapping having an assigned score greater than a score threshold.

5. The system of claim 1, wherein the subset of the plurality of languages includes a predetermined number of the plurality of languages included in the stored mapping having highest assigned scores.

6. The system of claim 1, wherein the electronic processor is configured to transcribe the audio data received from the sender using the language model associated with each of the plurality of candidate languages in parallel to generate the plurality of transcriptions.

7. The system of claim 1, wherein the audio data includes streaming audio data.

8. The system of claim 1, wherein the electronic processor is configured to update the stored mapping by updating an assigned score of a language included in the plurality of languages of the stored mapping, wherein the language was used to generate the one of the plurality of transcriptions.

9. The system of claim 1, wherein the electronic processor is configured to update the stored mapping by incrementing a counter associated with a language included in the plurality of languages of the stored mapping, wherein the language was used to generate the one of the plurality of transcriptions.

10. The system of claim 1, wherein the electronic processor is configured to update the stored mapping by increasing a rank associated with a language included in the plurality of languages of the stored mapping, wherein the language was used to generate the one of the plurality of transcriptions.

11. A method for converting data using a language model, the method comprising:
determining, with an electronic processor, a first property of a first user;
accessing, with the electronic processor, a stored mapping for the first property, the stored mapping including a plurality of languages associated with the first property, wherein each of the plurality of languages has an assigned score;
determining, with the electronic processor, a first plurality of candidate languages for the first user by selecting a first subset of the plurality of languages included in the stored mapping based on the assigned score of each of the plurality of languages;
receiving, with the electronic processor, first data from the first user;
converting, with the electronic processor, the first data into second data using a language model associated with each of the first plurality of candidate languages to generate a first plurality of data conversions;
determining, with the electronic processor, a confidence score for each of the first plurality of data conversions;
selecting, with the electronic processor, one of the first plurality of data conversions based on the confidence score for each of the first plurality of data conversions;
updating, with the electronic processor, the stored mapping based on the one of the first plurality of data conversions;
determining, with the electronic processor, a second property of a second user; and
in response to the second property matching the first property,
accessing, with the electronic processor, the stored mapping as updated,
determining, with the electronic processor, a second plurality of candidate languages for the second user by selecting a second subset of the plurality of languages included in the stored mapping based on the assigned score of each of the plurality of languages, and
converting, with the electronic processor, third data into fourth data using a language model associated with each of the second plurality of candidate languages.

12. The method of claim 11, wherein determining the first property of the first user includes determining at least one selected from a group consisting of a geographic location of the first user, an enterprise associated with the first user, an age of the first user, a profession of the first user, and a gender of the first user.

13. The method of claim 11, wherein receiving the first data includes receiving audio data and wherein converting the first data into the second data includes converting the audio data into text data.

14. The method of claim 11, wherein receiving the first data includes receiving text data.

15. A non-transitory, computer-readable medium storing instructions that, when executed by an electronic processor, perform a set of functions, the set of functions comprising:
determining a property of at least one selected from a group consisting of a user and data;
accessing a stored mapping for the property, the stored mapping including a plurality of languages associated with the property, wherein each of the plurality of languages has an assigned score;
determining a plurality of candidate languages by selecting a subset of the plurality of languages included in the stored mapping based on the assigned score of each of the plurality of languages;
converting the data using a language model associated with each of the plurality of candidate languages to generate a plurality of data conversions;
determining a confidence score for each of the plurality of data conversions;
selecting one of the plurality of data conversions based on the confidence score for each of the plurality of data conversions; and
updating the stored mapping based on the one of the plurality of data conversions.

16. The non-transitory, computer-readable medium of claim 15, wherein the property includes a geographic location of the user and wherein determining the geographic location includes determining the geographic location based on at least one selected from a group consisting of a phone number of the user, an Internet Protocol (IP) address of a user device used by the user, metadata associated with the data, and a profile of the user.

17. The non-transitory, computer-readable medium of claim 15, wherein updating the stored mapping includes updating the assigned score of a language included in the plurality of languages of the stored mapping, wherein the language was used to generate the one of the plurality of data conversions.

18. The non-transitory, computer-readable medium of claim 15, wherein updating the stored mapping includes incrementing a counter associated with a language included in the plurality of languages of the stored mapping, wherein the language was used to generate the one of the plurality of data conversions.

19. The non-transitory, computer-readable medium of claim 15, wherein updating the stored mapping includes increasing a rank associated with a language included in the plurality of languages of the stored mapping, wherein the language was used to generate the one of the plurality of data conversions.

20. The non-transitory, computer-readable medium of claim 15, wherein the data includes audio data and wherein each of the plurality of data conversions includes a transcription of the audio data.
